(19) United States
(12) Patent Application Publication
(10) Pub. No.: US 2016/0184745 A1
(43) Pub. Date: Jun. 30, 2016

(54) Device for taking samples from municipal and/or industrial wastewater

(71) Applicant: Endress + Hauser Conducta Gesellschaft für Mess- und Regeltechnik mbH + Co. KG, Gerlingen (DE)

(72) Inventors: Maike Haslauer, Stuttgart (DE); Joachim Albert, Leonberg (DE); Guido Mennicken, Leonberg (DE); Matthias Knodler, Fellbach (DE)

(21) Appl. No.: 14/970,833

(22) Filed: Dec. 16, 2015

(30) Foreign Application Priority Data
Dec. 22, 2014 (DE) 10 2014 119 441.1

(51) Int. Cl. B01D 29/68; B01D 35/02; G01N 1/10; B01D 39/16

(52) U.S. Cl. CPC B01D 29/68; B01D 39/16; B01D 35/02; G01N 1/10; B01D 2239/1216; G01N 2001/1031

(57) ABSTRACT

The invention refers to a device for taking samples from municipal and/or industrial wastewater that contains a filter (3) and which may be connected to a pressure pipe that carries fibers and particles. For a device, which is designed in a robust and cost-efficient way, while, at the same time, showing a long-lasting service life, the cylinder-shaped filter (3) has been positioned inside of a housing (2), with a hollow space (9) arranged between the housing (2) and the filter (3) that allows for the filter (3) to be washed around, with the filter (3) having a pore size of less than 50 μm, preferably between 0.5 and 20 μm.

The invention refers to a device for taking samples from municipal and/or industrial wastewater; it contains a filter and may be connected to a pressure pipe that carries fibers and particles.

Due to a high content of fibers and particles in wastewater, there are numerous problems with regards to taking samples from municipal and/or industrial wastewater. In a widely-used technology of taking samples from a pressure pipe, the wastewater is pumped to the measuring point through pipes. There are systems for taking samples from a pressure pipe, with which the sample to be analyzed is lead to the measuring device without being filtered. Such measurements, however, without prior filtering of the sample, may not be performed with numerous analyzing methods, as e.g. with the analysis of ammonium and orthophosphate.

As an alternative, sample taking systems that make use of a filter cartridge are known. Such filter cartridges have a complex structure and, therefore, are highly cost-intensive. In addition, they are not suitable for samples with a high content of fibers and particles, such as raw wastewater. Municipal or industrial wastewater will often cause a clogging layer to develop on the filter and thereby to block the filter unit.

Based on yet another design, sample taking systems are known, which make use of metal strainers. Such metal strainers have a pore size of >50 μm. For pore sizes smaller than that, metal-strainers are not suitable for the purpose of sample taking from a pressure pipe. In media that contain a high content of particles and fibers as in the case of municipal and/or industrial wastewater, the strong pressure that occurs on the filter will cause the welded seams to fail, which especially applies to the filters supposed to be cleaned by way of back-flushing, which puts an alternating strain on the welded seams, when coming from the inside, as well as from the outside.

The invention is based on the task of providing a device for taking samples which, on the one hand, has a long service life and yet, on the other hand, has a robust and cost-effective design.

Regarding the invention, the task has been solved in such a way that the filter with its cylinder-shaped design is contained in a housing so that there is a hollow space between the housing and the filter which allows for the filter to be washed around by the wastewater, while the filter has a pore size of less than 50 μm, preferably between 0.5 and 20 μm. A filter with a pore size as small as this is very well suited for taking samples from municipal and/or industrial wastewater, and, in addition, regarding its structure, it is very easily manufactured, which again means a reduction of costs.

In one version the filter is made of a certain type of plastic. Certain plastics have an extremely high resistance to acids, lye and organic solvents as they occur in wastewater. Thus the surface of the filter will not be affected, and corrosion of the filter can be avoided.

In one embodiment the plastic material selected is polyethylene, polypropylene or a type of polytetrafluoroethylene (PTFE). These types of plastic are highly resistant to acids, lye and organic solvents.

In one particular model of embodiment the filter has been manufactured by making use of a sintering process or of a melt-blowing process. Filters which have been manufactured by making use of these processes show a particularly favorable and even surface structure.

In one version, an inner pipe is positioned inside the cylinder-shaped filter, which—in an opening—contains a cover plug at the output of the cleaned sample. This way, the filtered wastewater may be discharged from the inner pipe for analysis without any need for additional tools.

As an advantage, the inner pipe is equipped with drill holes, located almost vertically to the direction of its extension, which allow for the intake of the filtered sample from the wastewater. Due to the filter being washed around by the wastewater and the small size of the pores in the filter, the fibers and particles are retained at the outer surface of the filter, so that only cleaned sample liquid may reach the inner pipe, in order to be discharged for analysis from there.

In one embodiment there are two drill holes respectively located radially on the inner pipe and at a distance of 180° from each other, whereas halfway on the distance between the first and the third pair of drill holes there is another pair of drill holes which is positioned at an angle of 90° to the first and the third pair. This way the drill holes are evenly spread over the inner pipe and thus the filtered wastewater may penetrate the inner pipe from all sides. The appearance of any congestion is steadily avoided.

A further developed version comprises a three-way valve located behind the cover plug which, in one position, carries the filtered sample to an analyzing device and, in another position, for the purpose of the back-flushing of the filter, passes a cleaning liquid into the inner pipe. Due to the back-flushing of the cleaning liquid, in particular, the downtime of the filter between two times of manual cleaning is increased and the amount of maintenance required for the operation of the measuring point is decreased. Regarding the means for cleaning, compressed air, water or a liquid cleanser shall preferably be used.

In one embodiment there is a sample inlet close to the cover plug and a sample outlet close to the end cap, located almost vertically in reference to the direction of extension of the filter, whereas the end cap and the cover plug are located at opposite ends of the inner pipe. Due to the offset positioning of sample inlet and sample outlet, it is secured that the whole body of the filter is washed around by the wastewater to be analyzed.

As an advantage, a sealing element is positioned between the sample outlet and the end cap of the inner pipe. Such a sealing element shields the occurrence of dead volume at the end of the inner pipe, since that would clog the interior of the inner pipe and redirect the liquid into the direction of the sample outlet. In one embodiment the sealing element is designed as a glued-in ball. In addition, a casting compound could be stuck like glue between the sealing element and the end cap.

In one embodiment a pressure element is inserted in the area of the sample outlet. Thus the sample outlet comprises a pressure element. The pressure element takes care of a pressure increase in the filter. The pressure element could be designed as a pressure plate, for instance, one made of rubber. A pressure plate in the sense of the invention shall be considered to be a disc equipped with one or more holes having the same diameter or having different diameters.

The invention allows numerous embodiments. Several of them shall be explained below, with reference to the figures that are depicted in the drawings.

There are illustrated:

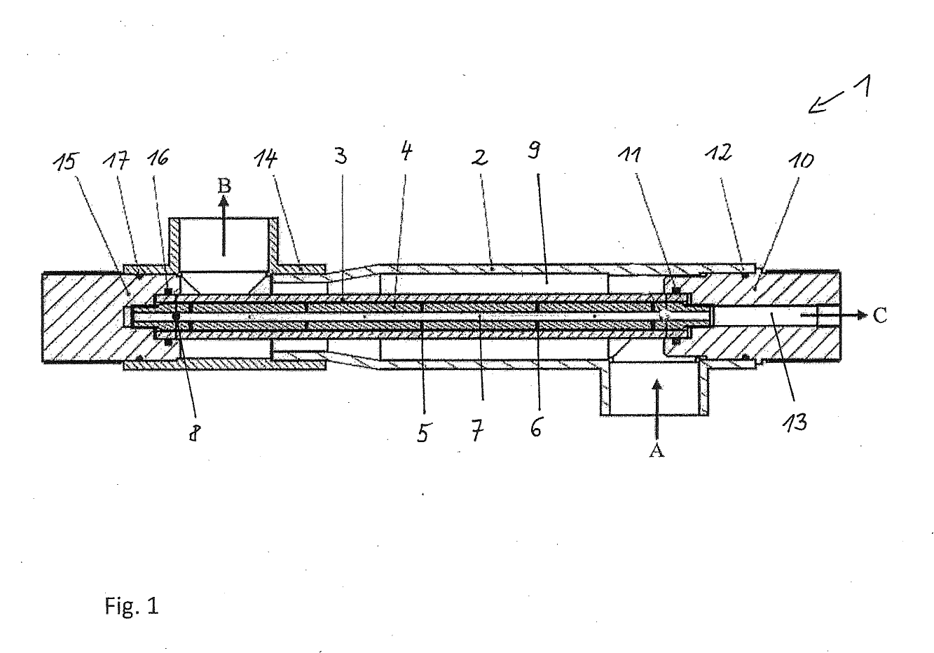

FIG. 1 a third example of an embodiment of a plug-in connection according to the invention.

In FIG. 1 is shown a device 1 for taking samples from municipal and/or industrial wastewater that comprises a housing 2, in which a filter 3 is extending lengthwise. The filter 3 has a cylinder-shaped design and is positioned to the housing 2 in such a way that there is a hollow space 9 between the housing 2 and the filter 3. Inside of the cylinder-shaped filter 3 an inner pipe 4 is contained which, at one inner wall of the filter 3 fully touches the surface of the filter. At certain intervals the inner pipe 4 shows drill holes at opposite sides 5, 6, whereas halfway between two pairs of drill holes 5, 6 there is an additional pair of drill holes 7, which is positioned at an angle of 90°. The pattern of drill holes 5, 6, and 7 is repeated over the whole length of the inner pipe 4.

On one side, the inner pipe 4 is limited by a sealing element 8, which keeps away the development of dead volume inside of the inner pipe 4. The sealing element 8 is designed as a glued-in ball. In addition, a casting compound is stuck like glue between the sealing element 8 and the end cap 15.

In the area of sample outlet B a pressure element shall be inserted (not shown on the figure). Thus sample outlet B comprises a pressure element for raising the pressure inside the filter 3. The pressure element is a pressure plate made of rubber, i.e. it is formed by a disc with one or more holes having the same diameter or different diameters.

As an advantage, the design of the housing 2 is T-shaped and shows a sample inlet A which is formed lengthwise to the vertical extension of the filter 3. The inner pipe 4 is closed with a cover plug 10, whereas one sealing gasket 11 is positioned between the cover plug 10 and the filter 3 and another one 12 between the housing 2 and the cover plug 10. The inner pipe 4 projects into a continuous opening 13 in the cover plug 10, which forms outlet C for the outflow of the filtered sample. At the opposite end of the housing 2, another T-piece 14 is attached by having the other end of the inner pipe 4 inserted into the T-piece 14. The other end covers sample outlet B of the device 1 and ends in another cover plug 15, which, also by means of sealing gaskets 16, 17, is pushed into the second T-piece 14.

As an advantage, the filter 3 consists of the synthetic materials of polyethylene, polypropylene or polytetrafluoroethylene (PTFE), which are highly resistant to acids, lye and organic solvents and which will have an average pore size between 0.5 and 20 μm. The filter 3 is being completely washed around by the pressurized water, which flows in through the sample inlet A of the device 1 and spreads in the hollow space 9.

Through the drill holes 5, 6, and 7, the cleaned sample will be forwarded to the inner pipe 4, while the fibers and particles get stuck on the outside of the filter 3. The opening 13 of the cover plug 10 thereby forms outlet C for the cleaned sample. Unclean water will leave the device 1 through sample outlet

B.

There is no further detailed illustration of a three-way valve, which is positioned behind the outlet for the filtrate C and which serves two different tasks. On the one hand, with the three-way valve in one position, the filtrate, which is exiting the inner pipe 4, will be forwarded to an analyzer. On the other hand, when the three-way valve is in a different position, then, by way of overpressure from the outside to the inside, a cleaning agent will be pushed into the inner pipe 4, which will flow to the outside through the drill holes 5, 6, and 7 and then through the filter 3, thereby detaching stuck dirt that occurs in the form fibers and particles. The dirt will be carried out of the device 1 via sample outlet B. With the help of such a cleaning medium like e.g. air, water or a liquid cleanser the filter 3 will be flushed through in the opposite direction of the filtration.

A particularly even surface structure, which allows for reliable cleaning of the filter 3, is given to the filter 3 in the case that it has been manufactured by making use of a sintering process or a melt-blowing process. In the case of the melt-blowing process, a thermoplastic synthetic material in the form of pellets is melted in an extruder and then pressed through a large number of very fine jets. Immediately, after having exited the jets, the single filaments are stretched and swirled through hot air that is blown into the direction from where they are exiting the jets and thus the filaments are consolidated into extremely thin continuous filaments within just a few milliseconds. These filaments are then directly put as a layer onto a carrier and may then be used as a filter. In the case of a sintering process, out of a powdery source material, spatial structures are being created.

The described device allows for samples to be taken from municipal and/or industrial wastewater, whereas the device is robust, easy to manufacture and still has a long service-life and is also suitable for back-flushing the filter 3.

1. Device for taking samples from municipal and/or industrial wastewater, which contains a filter (3) and may be connected to a pressure pipe that carries fibers and particles and which is characterized through the feature of having a cylinder-shaped filter (3) positioned in a housing (2), wherein there is a hollow space (9) between the housing (2) and the filter (3) to allow for the filter (3) to be flushed around with the wastewater, while the filter (3) has a pore size of less than 50 μm, preferably between 0.5 and 20 μm.

2. Device according to claim 1, characterized in that it the filter (3) is made of a synthetic material.

3. Device according to claim 2, characterized in that the synthetic material is a polyethylene, a polypropylene or a polytetrafluoroethylene.

4. Device according to claim 1, characterized in that the filter (3) has been manufactured either by making use of a sintering process or of a melt-blowing process.

5. Device according to claim 1, characterized in that an inner pipe (4) is positioned inside the cylinder-shaped filter (3) and that the inner pipe (4) ends in an opening (13) at the cover plug (10) that leads to the outlet for the cleaned sample.

6. Device according to claim 5, characterized in that the inner pipe (4) has holes (5, 6, and 7) for the intake of the filtered sample from the wastewater, for which purpose the holes are positioned almost vertically to the direction of the extension of the inner pipe.

7. Device according to claim 6, characterized in that there are respectively two holes (5) placed radially at a distance of approximately 180° from each other on the inner pipe (4), wherein between a first and a third pair of drilled holes (5, 6) there is another pair of drilled holes (7), which is positioned offset to the first and the third pair of holes (5, 6) at an angle of 90°.

8. Device according to claim 1, characterized in that a 3-way valve is positioned behind the cover plug (10), which valve, when being in its first position, forwards the filtered sample to an analyzing device and, when being in its second position, adds a cleaning liquid to the inner pipe (4) for the purpose of back-flushing the filter (3).

9. Device according to claim 1, characterized in that a sample inlet (A) located close to the cover plug (10) and a sample outlet (B) near an end cap (15) are positioned almost vertically to the direction of the extension of the filter (3), wherein the end cap (15) is positioned at the opposite end of the inner pipe (4) of where the cover plug (10) is located.

10. Device according to claim 1, characterized in that a sealing element (8) is positioned between the sample outlet (B) and the end cap (15) in the inner pipe (4).
